(19) United States
(12) Patent Application Publication
(10) Pub. No.: US 2001/0049722 A1
(43) Pub. Date: Dec. 6, 2001

(54) Method and apparatus of providing advice or services to one or more users

(76) Inventor: Bradley B. Bush, Austin, TX (US)

Correspondence Address: DAVIS & JOHNSON, LLP, P O BOX 90698, AUSTIN, TX, 78709-0698, US

(21) Appl. No.: 09/760,527

(22) Filed: Jan. 16, 2001

Related U.S. Application Data
(60) Provisional application No. 60/176,656, filed on Jan. 14, 2000.

(51) Int. Cl. G06F 15/16; G09G 5/00

(52) U.S. Cl. 709/204; 345/705; 345/751; 709/238

(57) ABSTRACT

The present invention is a method and apparatus for providing advice or services to a plurality of users. In general, the present invention includes the collection of experts in various disciplines and provides a mechanism for providing advice or answering questions to a plurality of users.

### CROSS REFERENCE TO RELATED APPLICATION

This application claims priority under 35 U.S.C. § 120 to co-pending, commonly owned U.S. provisional patent application Ser. No. 60/176,656 filed Jan. 18, 2000, entitled METHOD AND APPARATUS OF PROVIDING ADVICE OR SERVICES TO ONE OR MORE USERS which is incorporated by reference herein.

### FIELD OF THE INVENTION

This invention relates in general to a mechanism for providing and routing information. In particular, this invention is drawn to a method and apparatus for providing information or advice to users.

### BACKGROUND OF THE INVENTION

There is an ongoing need for providing people with advice or answering their questions. Depending on the type of information required, a person may find answers to questions by seeking the professional services of an individual. For example, a person with a medical question may ask a doctor. A person with a legal question may ask an attorney. In the same manner, people with other specific questions may turn to people with an expertise in the area in question.

One problem with obtaining advice or getting answers to questions is that the answer can be costly. In some cases, especially in the case of lower income or younger people, the cost can be prohibitively expensive. Another problem is that people may not know who to ask or from whom to seek advice. Another problem is that for any one question, there may be many answers or opinions, where each person asked may only provide one answer or opinion. In some cases, it is beneficial to have multiple opinions.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating the present invention on an Internet environment.

FIG. 2 is a flowchart illustrating one example of how an inquiry may be handled by the present invention.

### DETAILED DESCRIPTION

The present invention is a method and apparatus for providing advice or services to a plurality of users. In general, the present invention includes the collection of experts in various disciplines and provides a mechanism for providing advice or answering questions to a plurality of users.

As mentioned above, there is a need for providing answers to questions or providing advice to people in an inexpensive manner. One feature of the invention is that the invention may draw on a resource that is currently underutilized. The population of retired individuals and senior citizens grows every day and will continue to do so. Almost every retiree is skilled or is an expert in some field based on professions or life experiences (e.g., plumbers, mechanics, teachers, financial advisors, physiologists, computer technicians, homemakers, parents, cooks, people skilled in a certain hobby, etc.). In addition, while retirees may be retired from their profession, some are eager to continue to help other people, especially younger people or lower income people who may not be able to afford advice from professionals. In addition, many retirees and senior citizens have a desire to give back to the community, which can be realized by sharing advice with other people.

In one embodiment of the present invention, a collection of retired individuals is assembled to serve as a source of advice or a source for answers to questions. Of course, the collection does not have to be limited to retirees. For the purposes of this description, these individuals will be referred to as “experts”. Since the experts each have an area of expertise, or experience, each expert will be qualified to answer questions or provide advice in certain areas. Therefore, in one embodiment of the invention, the experts are categorized based on their areas of expertise. Since the experts may have multiple areas of expertise, each may be listed under several categories. For example, a former automotive mechanic may also have experience hang gliding or may be diabetic, etc., and therefore may be able to provide advice or answer questions in any of these areas.

The present invention provides a mechanism for routing questions from one or more users to the collection of experts. In one embodiment of the invention, a server is provided to facilitate the solicitation of inquiries from users. A user can send an inquiry to the server, which then routes the inquiry to one or more appropriate experts. After obtaining a response from one or more experts, the server can route the response back to the user. The inquiry may take on many forms. In one example, an inquiry may be a specific question, such as “How can I transfer the title of my house to my spouse?”. In this example, the user is asking a specific question, and is expecting an answer to the question. In another example, the inquiry may be a prelude to a specific question such as “I have a question for a lawyer.”. In the first example, the server may route the inquiry to an appropriate expert, such as a lawyer. In the second example, the server may respond to the inquiry by showing the user how to ask an appropriate expert.

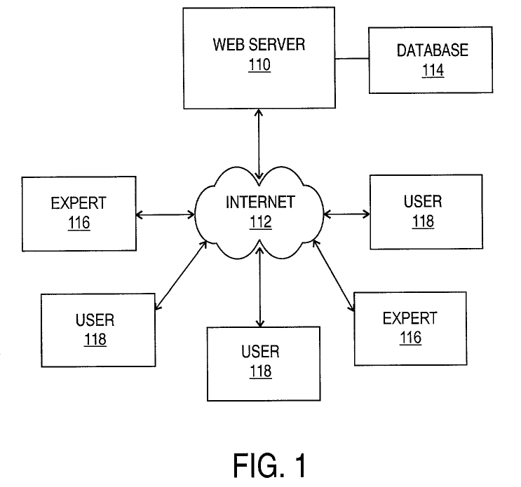

In the preferred embodiment of the present invention, the invention is implemented in an Internet environment. FIG. 1 is a block diagram of one example of how the invention could be implemented in an Internet environment. FIG. 1 shows a web server 110 connected to an Internet 112. The web server 100 includes, or is connected to a database 114. A web site resides on the web server 110. FIG. 1 also shows a plurality of experts 116 and a plurality of users 118 connected to the Internet 112. In this way, each of the experts 116 and users 118 can communicate with the web server 110 via the Internet 112.

In one embodiment, the database 114 stores information relating to each of the experts 116. The information may include the expert's identity, contact information, education levels and degrees, profession, areas of expertise, etc. This information can be used by the web server 110 to place the experts into various categories. For example, one expert may be a doctor in Alaska who also has a certain medical condition. The web server may use that information to route inquiries to the expert, which may relate to medicine, traveling to Alaska, or about the expert's medical condition, for example. The web server 110 may categorize the experts into pre-determined groups (e.g., specific professions, specific geographic locations, etc.), or may dynamically categorize the experts as inquiries are received (i.e., by selecting an expert depending on the content of the inquiry). In the example of pre-determined groups, a medical inquiry may get routed to one or more experts in the “medical” category. In the example of dynamic categorization, a medical inquiry may get routed to an experts that have medical-type of information stored in the database 114.

Once the web server 110 receives an inquiry and it is routed to an appropriate expert, the web server awaits a response from the expert. When a response is received, the web server 100 routes the response to the user who submitted the inquiry. If necessary, the user may submit a follow-up inquiry, which will be routed to the expert. The expert may then respond to the follow-up inquiry.

Following is a description of one example of the operation of the present invention. This example assumes that the Internet environment such as that shown in FIG. 1 is being used. Of course, other environments may be used. For this example, we will assume that there is a user 118 who wants to know how to transfer the title of a house to a spouse. The user 118 first uses a web browser to go the web page hosted by web server 110. The user 118 then performs any necessary login procedures. For example, a user may be required to set up a username and password, for example. Once the user 118 is logged on, an inquiry is entered in the appropriate text box on the web page. For example, the user may enter “How can I transfer the title of my house to my spouse?”. The web server 110 then routes the inquiry to an appropriate expert 116, for example, a lawyer. As mentioned above, the appropriate expert 116 can be selected based on the content of the message, or by the user first indicating an appropriate subject matter (e.g., “legal issue”). Once the expert 116 receives the inquiry, the expert can respond to the inquiry via the web page, or some other suitable mechanism. The web server 110 then routes the response to the user 118 via email or via the web site when the user 118 logs in again.

The present invention may include various variations. For example, the steps of routing the inquiries and responses between the users and the experts may take on many forms. In one example, all the routing may go through the web site (as described above). In another example, the web server 110 may simply provide the user or expert instructions on how to communicate with each other. In this example, after receiving an inquiry, the web server 110 may simply respond to the user by saying something like “Here is an email address for an expert that can help you with your question”, along with any contact information. In another embodiment, the invention can be implemented in a message board format. In this example, a user can post a question on the message board and wait for an expert to respond to the post. If desired, the message board can be viewed by anyone so that the advice provided by the expert can be shared with anyone who needs it. In another embodiment, responses to inquiries can be stored in a searchable database so that users can search or answers to questions previously answered. In another embodiment, articles or other documents may be stored on the server so that users can have access to them either by searching text, or searching by subject to title. For example, an expert may provide articles about topics for which the author is an expert. In other examples, the documents may include recipes, instructions for performing a task, etc.

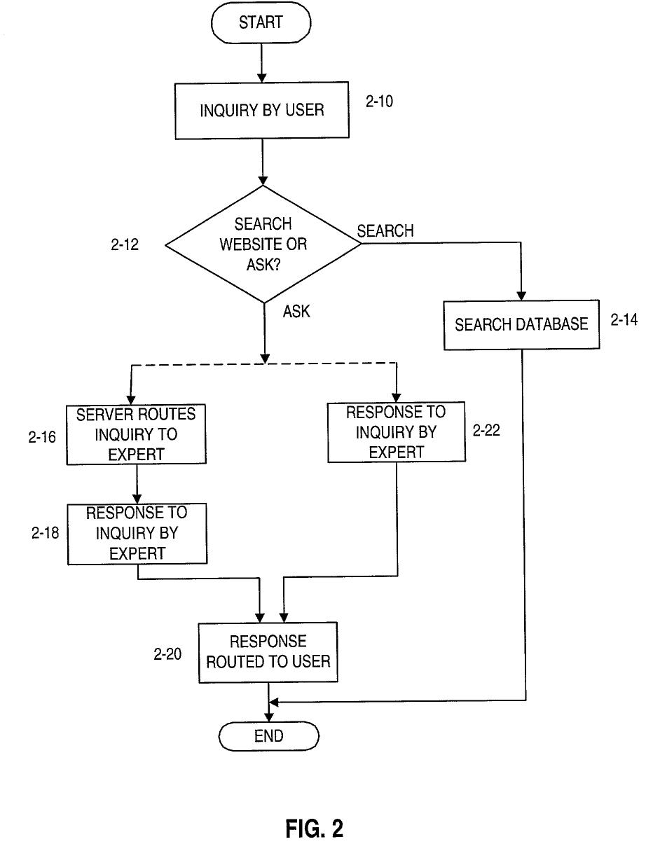

FIG. 2 is a flowchart graphically illustrating one example of how an inquiry may be handled by the present invention. When a user has an inquiry (step 2-10), the user has the option (step 2-12) of going to a web site and either searching a database of archived inquiries and responses, or of submitting a new inquiry. If the user chooses to search the database (step 2-14), the process ends after the user searches the database. Of course, the user may start the process shown in FIG. 2 again if a satisfactory answer is not found. If the user chooses to submit an inquiry, the inquiry is routed to an expert. In a first example, the server routes the inquiry to an expert (step 2-16) based on the areas of expertise of the experts (described above). Once the expert responds to the inquiry (step 2-18), the response is routed to the user (step 2-20). In a second example, the inquiry is submitted directly to the expert and once the expert provides a response (step 2-22), the response is routed to the user (step 2-20).

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

What is claimed is:

1. A method of providing advice or services to a plurality of users comprising the steps of:
providing a collection of individuals, each individual having an area of expertise;
soliciting one or more inquiries from one or more of the plurality of users;
routing the inquiries to one or more of the individuals so that the individuals can provide a response to the inquiry; and
routing any responses to the inquiries to the one or more of the plurality of users.

2. The method/apparatus of claim 1, further comprising the step of providing a server, wherein the inquiries and responses are routed by the server.

3. The method/apparatus of claim 2, wherein the server is a web server.

4. The method/apparatus of claim 1, wherein the inquiries are routed to specific individuals based on the areas of expertise of the individuals.

5. A method of providing advice or services to a plurality of users comprising the steps of:
providing a web site residing on a web server;
providing a connection from the web server to a collection of individuals;
soliciting inquiries on the web site;
upon receiving an inquiry from a user, routing the inquiry to one or more of the individuals so that the individuals can provide a response to the inquiry; and
upon receiving a response to the inquiry, routing the response to the user.

6. The method/apparatus of claim 5, wherein the step of routing the inquiry to one or more of the individuals further comprising the step of selecting an individual to receive the inquiry based on the area of expertise of one or more of the individuals.

7. A method of providing advice or services to a plurality of users comprising the steps of:
providing a web site residing on a web server;
providing a connection from the web server to a collection of individuals including retired individuals;
providing a plurality of categories of areas of expertise;
associating each of the individuals with one or more of the categories;
soliciting inquiries on the web site;
upon receiving an inquiry from a user, associating the inquiry with one or more of the categories;
routing the inquiry to one or more of the individuals associated with the inquiry; and
upon receiving a response to the inquiry, routing the response to the user.

8. An apparatus for providing advice or services to a plurality of users comprising:
a server;
a collection of individuals stored on the server;
wherein the server provides the functions of:
soliciting inquiries from a plurality of users,
upon receiving an inquiry from a user, routing the inquiry to one or more of the individuals so that the individuals can provide a response to the inquiry, and
upon receiving a response to the inquiry, routing the response to the user.

9. The apparatus of claim 8, wherein the server is a web server.
